(19) United States
(12) Patent Application Publication
(10) Pub. No.: US 2003/0115718 A1
(43) Pub. Date: Jun. 26, 2003

(54) Flap hinge

(76) Inventor: Ralph Bechthold, Remscheid (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/221,803

(22) PCT Filed: Mar. 21, 2001
(86) PCT No.: PCT/DE01/01097

(30) Foreign Application Priority Data
Mar. 21, 2000 (DE) 100 13 726.1

(51) Int. Cl. E05D 7/04

(52) U.S. Cl. 16/235

(57) ABSTRACT

The invention relates to a flap hinge for connecting a flap, a front lid or a boot lid for instance, to a body of a motor vehicle in an articulated manner. The inventive hinge comprises a first stop component (2) for fixing to the flap, a second stop component (3) for fixing to the body and a connecting member (4). Openings (7, 8) of the two stop components (2, 3) are interspersed by said member. At least one of the two stop components (2, 3) can be pivoted around said member (4) which is provided with thread sections (5, 6) on both ends thereof. An opening (7, 8) of one of the two stop components (2, 3) respectively is interspersed by said sections. Each one of the two stop components (2, 3) can be adjusted separately by means of detachable nuts (10, 11). The aim of the invention is to provide a flap hinge which enables a pivoting moment to be adjusted in a defined manner without affecting the adjustment of the position. At least one of the openings is configured as an elongated hole (7).

The invention relates to a flap hinge according to the preamble of claim 1 for the articulated connection of a flap, e.g. a front hood or a trunk lid, to a motor-vehicle body, comprising a first attachment part for fastening to the flap, a second attachment part for fastening to the vehicle body, and a connecting element, which passes through through-passages of the two attachment parts and around which at least one of the two attachment parts can be pivoted, wherein the connecting element is provided, at both ends, threaded sections, which each pass through a through-passage of one of the two attachment parts, and wherein each of the two attachment parts can be adjusted separately by means of releasable nuts.

Flap hinges for front hoods which comprise two attachment parts of which the single articulated connection is produced by a threaded bolt, the two attachment parts comprising an intermediate disk, which is positioned on the threaded bolt as well, and possibly maintenance-free bushings, that end of the bolt which is directed away from the head being accommodated in an internally threaded clamping part, are known from practice. In the case of the known flap hinge, it is also provided that one attachment part has a slot so that, once the bolt has been loosened, it can be adjusted in height in order for it to be possible to compensate for inaccuracies upon adjustment of the two hinges of a front lid or of the position of the front hood in the lock, in order for it to be possible to optimize the position of the front hood relative to the vehicle body as a whole. At the same time, the forces of the hinge are adjusted via the threaded bolt, that is to say the hinge can be adjusted to a smoother setting by virtue of the threaded bolt being loosened and to a stiffer setting by virtue of the threaded bolt being tightened. The disadvantage with the known flap hinge is the fact that, when the threaded bolt is loosened for adjusting the pivoting moment of the flap hinge, there is a risk, at the same time, of the already adjusted height setting being lost since, in the case of the threaded bolt being loosened too much, the slot falls under the load of the front hood. It is likewise the case, during the height adjustment, that there is always a risk of the bearing being damaged.

DE-A-40 32 930 shows a hinge joint, having a hinge pin as connecting element, from which a collar projects radially and of which the two ends are designed with threaded extensions onto which nuts can be screwed. An abutment plate for fastening to the vehicle body has the threaded extension passing through it. A hinge eyelet of an attachment part has the other threaded section passing through it. There is no provision for at least one of the through-passages in the attachment parts to be designed as a slot. The disadvantage with the hinge joint is, in particular, the fact that it is not possible, when a door is fitted in, to compensate for the tolerances without, at the same time, adjusting the pivoting moment of the hinge joint.

DE-C-443 051 describes the articulation of a door by means of two hinges, in the case of which a first hinge half is connected to a door element and a second hinge half is connected in a stationary manner to a door post, a hinge pin passing through in each case two angled wings of each of the two hinge halves. A bearing collar keeps at least one pair of the two hinge wings at a distance apart from one another. The hinge pin, at both ends, is provided with threaded sections which make it possible to apply nuts for securing the hinge pin. The through-passages in the wings of the door-post hinge half are designed as slots, in order for it to be possible for the door to be adjusted horizontally in the closed position of the hinge. The vertical adaptation takes place by using another bearing collar. The disadvantage of this articulation is, in particular, the fact that, when the nuts provided at one end or the other are loosened, the hinge pin can also move axially, with the result that this can also affect the sliding pairing with the second hinge half.

It is the object of the invention to provide a flap hinge according to the preamble of claim 1 which allows a defined pivoting-moment adjustment without adversely affecting the position setting.

This object is achieved according to the invention by the characterizing features of claim 1 in that at least one of the through-passages is designed as a slot.

The flap hinge according to the invention makes it possible, by virtue of the nut assigned to the first detached part being loosened, to adjust the height setting by displacing the slot relative to the threaded section without thus changing the setting of the torque at the second attachment part. By virtue of the nut assigned to the second attachment part being loosened, in contrast, it is possible for this torque to be adjusted without the height setting of the first attachment part being lost. It has to be understood that the thread of the threaded section can be limited, if appropriate, to the connecting-element ends intended for engagement with the nut, while the rest of the circumference of the threaded section is, for example, of smooth design or is set back from the circumference.

The connecting element is preferably designed with a circumferentially at least partially projecting disk, which is arranged in its central region and on both sides of which the threaded sections extend, with the result that in each case one of the first and second attachment parts can be arranged on both sides of the disk section and the disk prevents the attachment parts from rubbing against one another. Expediently provided for this purpose is a fully formed disk which is optionally designed in one piece with the connecting element, e.g. by being produced from a rotary part, into which the thread turns have then been chased, or by a single part having been formed by extrusion. It is alternatively possible for the disk just to be arranged between the threaded sections once the latter has been cut, to be retained in a form-fitting and force-fitting manner, for example, on a circumferential knurling, to be shrunk on or, if appropriate, if the disk is provided with an inner toothing formation, to be screwed into the desired position in the manner of a thread spindle and fixed in a stationary manner.

The disk preferably comprises, at least on one side, a stub section which is adapted to the through-passage of the attachment part abutting there and at least partially passes through the through-passage of the corresponding attachment part, the stub section being at least partially adapted to the contour of said attachment part. It is thus advantageously possible for the stub section assigned to the slot to have an outer contour, for example an oval contour, which prevents rotation in the slot but of which the length is considerably shorter than the length of the slot, with the result that displacement back and forth in the slot is possible. A further stub section, which is assigned to the second attachment part, on that side of the disk section which is directed away from the slot, in contrast, may have the cylindrical outer contour, in order to define a smooth-running joint as a mount for the likewise circular through-passage. The torque is then prominently adjusted by the nut being prestressed axially, in the direction of the threaded section, against the corresponding attachment part.

According to an alternative configuration, it is possible to provide slots in both attachment parts, said slots extending at an angle to one another, preferably such that height adjustment is possible in one slot and adjustment in the direction of travel of the vehicle is possible in the other slot. The pivoting moment of the flap hinge is then preferably set at the last-mentioned slot.

The flap hinge according to the invention may be designed as a single-joint hinge, in which case the connecting element coincides with the single pivot axis of the two attachment parts; it is alternatively possible for the flap hinge to be designed as a multiple-joint hinge, in which case the connecting element coincides with the articulation of a link of the multiple joint to one of the attachment parts, the first or the second attachment parts then analogously constituting a link which is articulated on the attachment part for fastening on the corresponding other arrangement part.

Further advantages and features of the invention will become apparent from the following description and from the dependent claims.

The invention is explained in more detail hereinbelow by way of a preferred exemplary embodiment and with reference to the attached drawings.

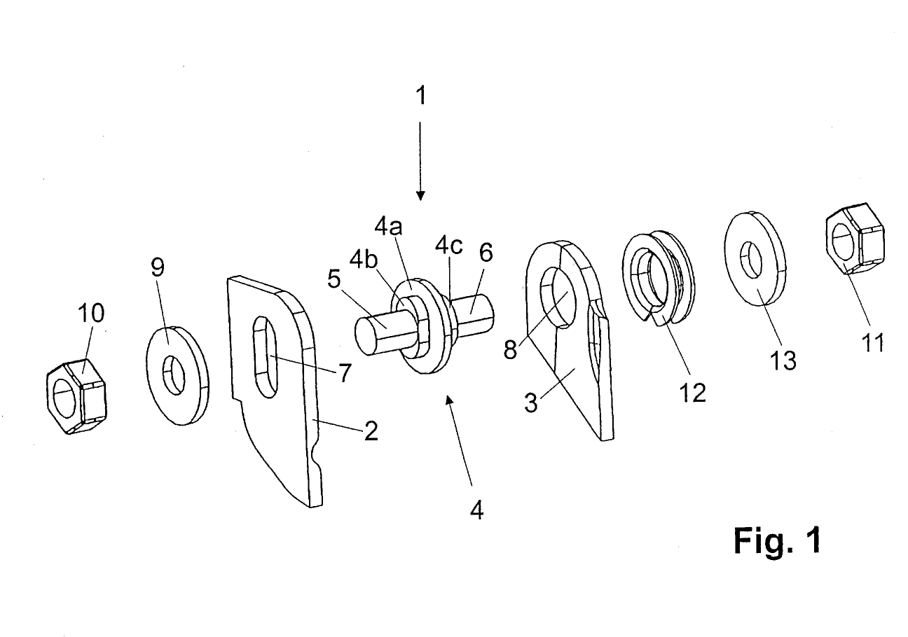

FIG. 1 shows an exploded illustration of a preferred exemplary embodiment of a flap hinge according to the invention, in the case of which only sections of the attachment parts are illustrated.

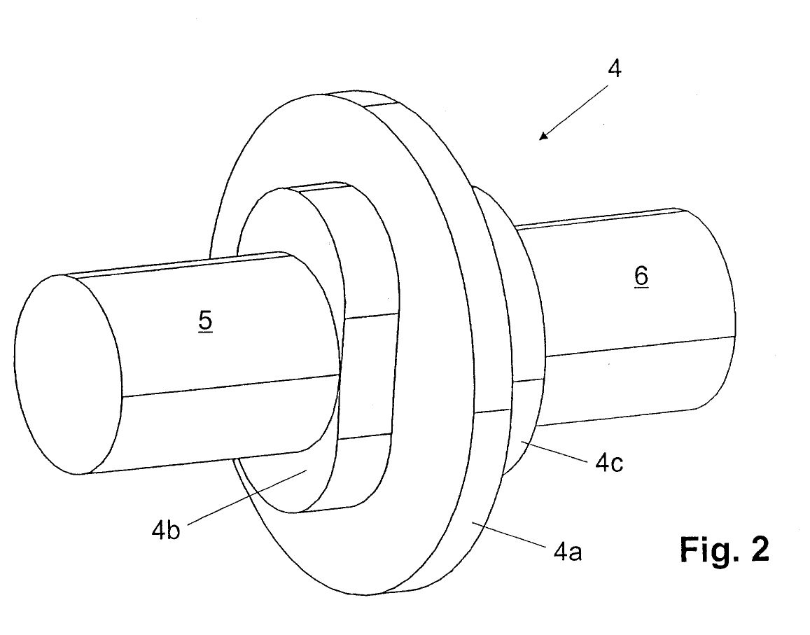

FIG. 2 shows a perspective view, on an enlarged scale, of a connecting element from FIG. 1.

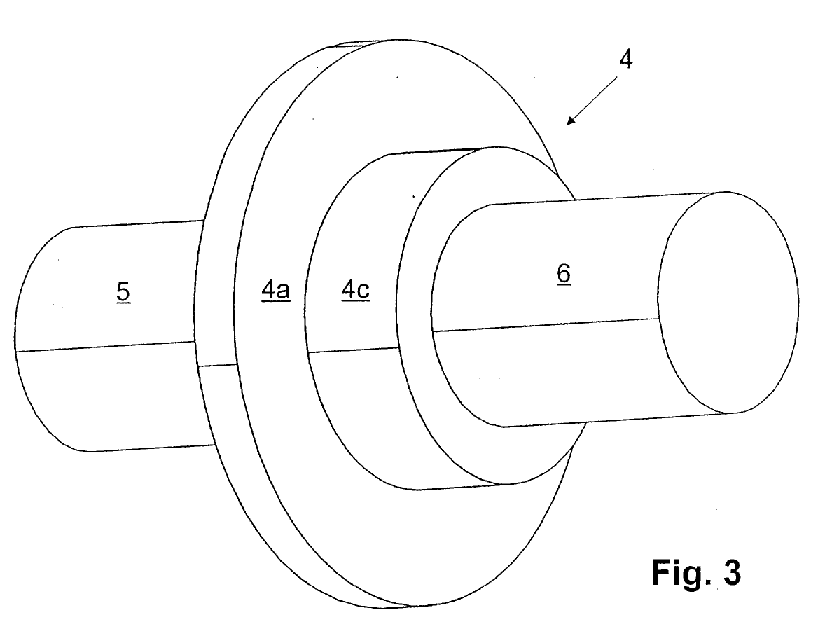

FIG. 3 shows the connecting element from FIG. 2 from another perspective.

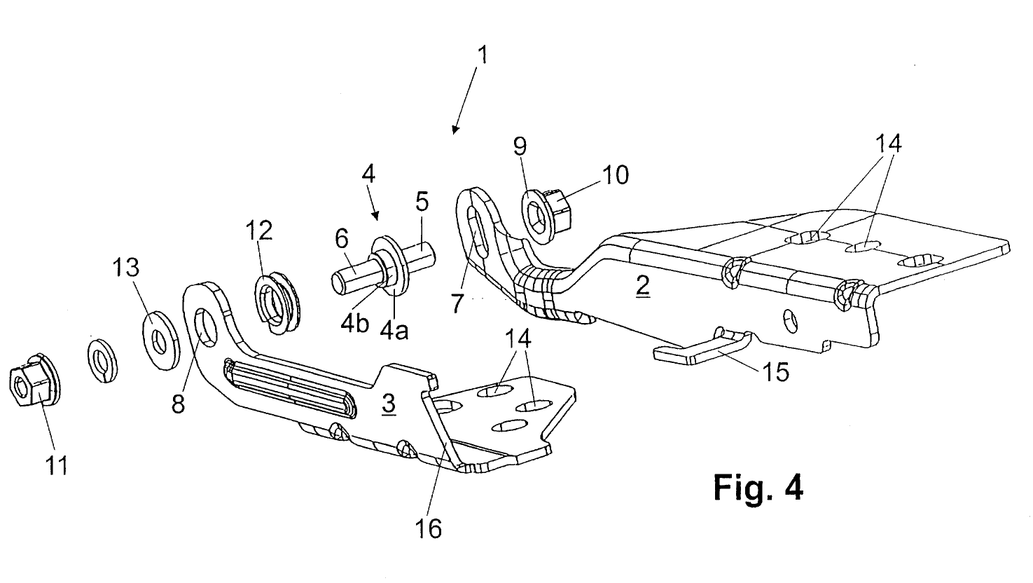

FIG. 4 shows an exploded illustration of the flap hinge from FIGS. 1 to 3 from another perspective.

The flap hinge, which is designated 1 overall in FIG. 1, comprises a first, flap attachment part 2 and a second, vehicle-body attachment part 3, which are connected to one another to form a pivoting joint via a connecting element, which is designated 4 overall and is produced as an extruded part.

The connecting element 4 comprises a threaded section 5, which is assigned to the flap attachment part 2, and a threaded section 6, which is assigned to the vehicle-body attachment part 3, the two threaded sections usually being provided with a circumferential thread, it being the case for assembly purposes that the threaded section 5 passes through a through-passage in the flap attachment part 2 in the form of a slot 7, while the threaded section 6 passes through a circular bore 8 in the vehicle-body attachment part 3. In the closed installation position of the flap hinge 1, the slot 7 extends in the vertical direction, irrespective of the geometry of the attachment part 2, and allows a height adjustment of the flap, which is adjusted by the flap hinge.

As can be seen in FIGS. 2 and 3 in particular, the connecting element 4 comprises a central projecting disk-like extension 4a, this disk section 4a being arranged in a non-releasable manner on the connecting element 4 between the two threaded sections 5 and 6 and defining an abutment for the two attachment parts 2, 3. This ensures that an abutment exists for each of the two attachment parts, with the result that the pivoting moment or the position, in particular height, of one attachment part can be adjusted independently of that of the respectively other attachment part.

The connecting element 4 comprises, projecting axially from the disk 4a, a first, oval stub portion 4b and, on the other side a cylindrical stub portion 4c, the stub portion 4b being designed for engaging with the slot 7 of the flap attachment part 2 and the stub portion 4c being designed for engaging in the bore 8 of the vehicle-body attachment part 3. The stub portion 4b is oval, the length of the oval being shorter than the length of the slot 7, with the result that axial displacement is possible in the direction of the long axis of the slot, while the width of the stub portion 4b is adapted in an essentially play-free manner to the width of the slot 7 such that the parallel edges ensure play-free guidance.

For the purpose of securing the flap attachment part, a washer 9 and a nut 10 are further placed in position on the threaded section 5, it optionally being possible for clamping means in the manner of a spring also to be provided between the washer 9 and nut 10. In the present exemplary embodiment, however, it is not necessary for the flap attachment part, which is provided with slot 7 to be arranged in a pivotable manner, with the result that the surface pressure of the washer 9 can secure the same.

The vehicle-body attachment part 3 is placed in position on the threaded section and screw-connected by a nut 11, a bushing 12 being arranged in abutment with that flat side of the vehicle-body attachment part 3 which is directed away from the disk 4a, and another washer 13 being arranged between said bushing and a nut 11, which is screwed onto the threaded section 5.

FIG. 4 illustrates an exploded illustration of a complete flap hinge 1 in perspective, said flap hinge being fitted, for example, on the right-hand side of a front lid, as seen in the direction of travel. The same designations designate the same parts as in FIG. 1. The oval stub portion 4b is not visible, on account of the perspective, but is nevertheless present, for passing through the slot 7 of the flap attachment part 2. FIG. 4 shows the bores 14 in the vehicle-body attachment part 3 for fastening on a motor-vehicle body and in the flap attachment part 2 for fastening on a front hood of a motor vehicle, it also being possible to see a hook 15, which projects laterally from the flap attachment part 2, engages over the essentially vertically arranged part 16 of the vehicle-body attachment part, and defines a pivoting-limiting means.

The invention, then, functions as follows:

The flap hinge 1 is assembled in accordance with the exploded illustration from FIG. 1 and is arranged on the flap via the attachment part 2. The pivoting moment of the flap hinge 1 is essentially adjusted by the stressing force of the nut 11, with the result that the flap, for example a front hood, can be introduced, together with the flap hinge 1, into the vehicle body, where the vehicle-body attachment part is screw-connected, or fastened in some other way, outside the joint via further through-passages (not illustrated). In order to align the flap with the fenders or other parts of the vehicle, it is expedient if, once the flap has been positioned, it can be adjusted in height by displacement of the stub 4b in the slot 7. For this purpose, in the case of the flap hinge 1, it is no longer necessary to loosen the entire connection, with the result that the pivoting moment of the flap does not change and does not have to be reset. Damage to the bearing is also expediently prevented as a result.

The invention has been illustrated above by way of an exemplary embodiment in the case of which the slot is arranged in the flap attachment part. It has to be understood that it is likewise possible for this through-passage, or some other through-passage which does not have a circular-cylindrical contour, to be provided in the vehicle-body attachment part, and that, as an alternative to securing the flap in the vertical direction, it is also possible for the longitudinal extent of the slot to be formed along an axis other than the vertical.

1. A flap hinge for the articulated connection of a flap, e.g. a front hood or a trunk lid, to a motor-vehicle body, comprising
a first attachment part (2) for fastening to the flap,
a second attachment part (3) for fastening to the vehicle body, and
a connecting element (4), which passes through through-passages (7, 8) of the two attachment parts (2, 3) and around which at least one of the two attachment parts (2, 3) can be pivoted,
wherein the connecting element (4) is provided, at both ends, threaded sections (5, 6), which each pass through a through-passage (7, 8) of one of the two attachment parts (2, 3), and
wherein each of the two attachment parts (2, 3) can be adjusted separately by means of releasable nuts (10, 11), characterized in
that at least one of the through-passages is defined as a slot (7).

2. The flap hinge as claimed in claim 1, characterized in that the connecting element (4) is designed with a circumferentially projecting disk section (4a), on both sides of which the threaded sections (5, 6) extend.

3. The flap hinge as claimed in claim 2, characterized in that the disk section (4a) is designed in one piece with the threaded sections (5, 6).

4. The flap hinge as claimed in claim 2 or 3, characterized in that the disk section (4a), at least on one side, has a stub section (4b, 4c) adapted to the through-passage (7, 8) of the attachment part (2, 3) abutting there.

5. The flap hinge as claimed in claim 4, characterized in that a stub section (4b), which is assigned to the slot (7), has an outer contour which prevents rotation in the slot (7) and allows securing in a longitudinal direction of the slot (7).

6. The flap hinge as claimed in claim 4 or 5, characterized in that the stub section (4b), which is assigned to the slot (7), has an oval contour.

7. The flap hinge as claimed in one of claims 4 to 6, characterized in that a stub section (4c), which is directed away from the attachment part (2) provided with slot (7), has a cylindrical outer contour for accommodating the through-passage (8) of the other attachment part (3).

8. The flap hinge as claimed in one of claims 1 to 6, characterized in that the two attachment parts (2, 3) have through-passages which are designed as slots (8) and are arranged essentially perpendicular to one another in the closed position.

9. The flap hinge as claimed in one of claims 1 to 8, characterized in that the connecting element (4) coincides with the single pivot axis of the two attachment parts (2, 3).

10. The flap hinge as claimed in one of claims 1 to 9, characterized in that the connecting element (4) is designed as a single-piece extruded part.

11. The flap hinge as claimed in one of claims 1 to 9, characterized in that the portions (4a; 4b, 4c), which are rigidly engaged with the connecting element (4), are retained by means of knurling, which is arranged between the threaded sections (5, 6).
